(19) United States
(12) Patent Application Publication
(10) Pub. No.: US 2021/0086408 A1
(43) Pub. Date: Mar. 25, 2021

(54) FOAMED MATERIAL FOR SHOES AND METHOD FOR MANUFACTURING THE SAME

(71) Applicant: Pou Chen Corporation, Chang Hwa Hsien (TW)

(72) Inventors: Tsung-Wei Kuo, Changhua City (TW); Shih-Chia Lin, Yuanlin City (TW); Hung-Wu Hsieh, Xizhou Township (TW); Chien-Jung Hung, Chang Hwa Hsien (TW)

(21) Appl. No.: 16/739,367

(22) Filed: Jan. 10, 2020

(30) Foreign Application Priority Data
Sep. 20, 2019 (TW) 108134056

(51) Int. Cl. B29C 41/00; A43B 13/18; B29C 41/02

(52) U.S. Cl. CPC B29C 41/003; B29K 2105/04; B29C 41/02; A43B 13/187

(57) ABSTRACT

A foamed material for shoes includes a foamed body made by foaming a mixture of a molten thermoplastic elastomeric material and a supercritical fluid. The foamed body has a density lower than 0.35 g/cm³, and includes multiple foamed pores, each of which extends in a longitudinal direction to terminate at two opposite lengthwise ends and in a width direction perpendicular to the longitudinal direction to terminate at two opposite widthwise ends. Each foamed pore has a maximum length defined by a distance between the lengthwise ends and a maximum width defined by a distance between the widthwise ends, and a ratio between the maximum length and the maximum width is at least 2:1. A method for manufacturing the foamed material is also disclosed.

### CROSS-REFERENCE TO RELATED APPLICATION

This application claims priority of Taiwanese Invention Patent Application No. 108134056, filed on Sep. 20, 2019.

### FIELD

This disclosure relates to a foamed material, and more particularly to a foamed material for shoes and a method for manufacturing the same.

### BACKGROUND

Taiwanese Patent Publication No. 1658076 discloses a method for making a low density foamed article which includes combining in an extruder a molten thermoplastic ethylene-vinyl acetate copolymer with a chemical blowing agent and a supercritical fluid to form a mixture, followed by injecting the mixture into a mold and molding the mixture to form the low density foamed article. However, the chemical blowing agent that aims to decrease a density of the thus obtained foamed article to, for example, less than 0.35 g/cm³, is not environmentally friendly, and therefore the foamed article containing the same might not be recyclable.

Taiwanese Patent Publication No. 1389953 discloses a method for making a polymeric foamed article, which involves not only use of the abovementioned environmentally unfriendly chemical blowing agent, but also raising pressure to increase an amount of foamed pores, which might result in difficulty to rotate a screw rod of an injection molding machine, thereby greatly increasing the manufacturing cost.

### SUMMARY

Therefore, an object of the disclosure is to provide a foamed material for shoes and a method for manufacturing the same, which can alleviate at least one of the drawbacks of the prior art.

According to the disclosure, the foamed material for shoes includes a foamed body made by foaming a mixture including a molten thermoplastic elastomeric material and a supercritical fluid. The foamed body extends in a first longitudinal direction and includes a plurality of foamed pores. The foamed body has a density lower than 0.35 g/cm³. Each of the foamed pores extends in a second longitudinal direction to terminate at two opposite lengthwise ends, and extends in a width direction to terminate at two opposite widthwise ends. Each of the foamed pores has a maximum length defined by a distance between the lengthwise ends, and a maximum width defined by a distance between the widthwise ends. For each of the foamed pores, a ratio between the maximum length and the maximum width is at least 2:1.

According to the disclosure, the method for manufacturing the foamed material for shoes includes the steps of: a) providing a molten thermoplastic elastomeric material in a first molding machine, b) delivering a supercritical fluid into the first molding machine and allowing the supercritical fluid to mix with the molten thermoplastic material so as to obtain a mixture, and c) delivering the mixture from the first molding machine into a second molding machine at a flow rate of greater than 200 mm/s and allowing the mixture to flow along a first longitudinal direction and to be molded to form the above mentioned foamed material including the foamed body that has the plurality of foamed pores.

### BRIEF DESCRIPTION OF THE DRAWINGS

Other features and advantages of the disclosure will become apparent in the following detailed description of the embodiment(s) with reference to the accompanying drawings, in which:

FIG. 1 is a schematic sectional view of an embodiment of a foamed material for shoes according to the disclosure;

FIG. 2 is a partially enlarged view of FIG. 1;

FIG. 3 is a schematic sectional view of a first molding machine and a second molding machine applied in an embodiment of a method for manufacturing the foamed material for shoes according to the disclosure;

FIG. 4 is a flow chart illustrating the embodiment of the method according to the disclosure; and

FIG. 5 is an enlarged sectional view illustrating a mixture being delivered into the second molding machine.

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

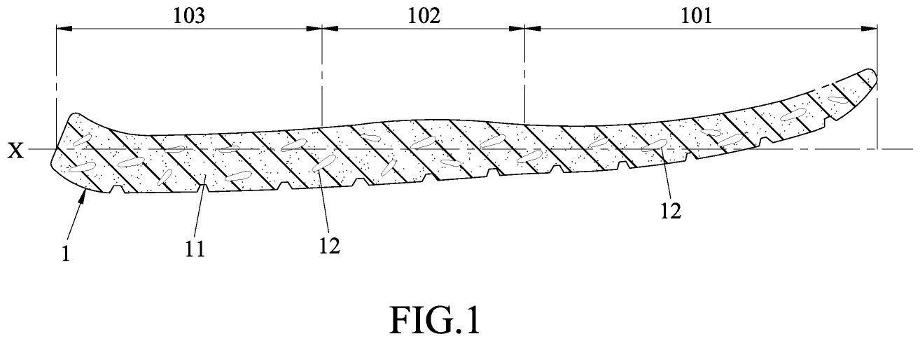

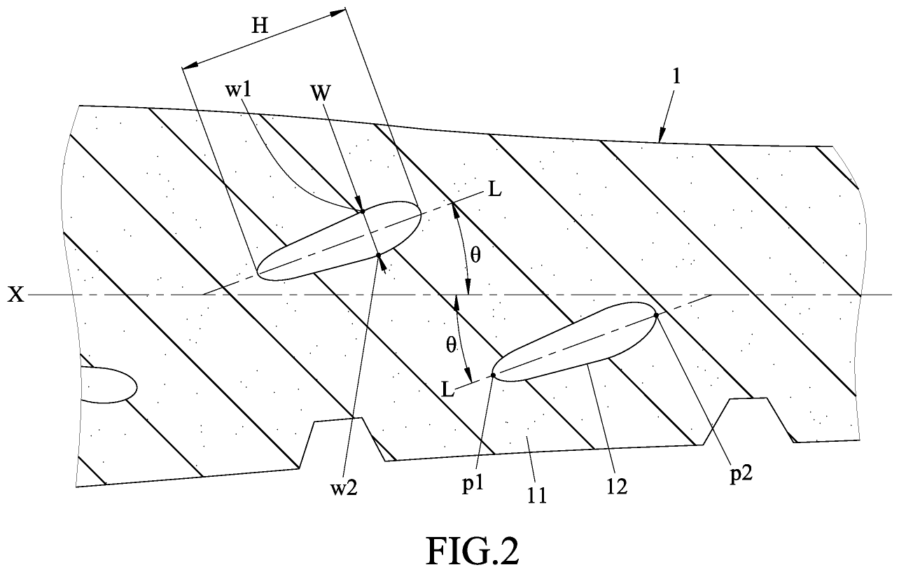

Referring to FIGS. 1 and 2, an embodiment of a foamed material for shoes according to the disclosure includes a foamed body 1 having a density lower than 0.35 g/cm³.

The foamed body 1 is made by foaming a mixture that includes a molten thermoplastic elastomeric material 11 and a supercritical fluid. Examples of the molten thermoplastic elastomeric material 11 may include, but are not limited to, a polyolefin elastomer (POE), a thermoplastic elastomer (TPE), and the combination thereof. Examples of the thermoplastic elastomer (TPE) include, but are not limited to, thermoplastic styrene (TPS or TPE-s), thermoplastic olefin (TPO or TPE-o), thermoplastic vulcanizates (TPE-v or TPV), thermoplastic polyurethanes (TPU) and thermoplastic polyester elastomer (TPE-E). Examples of the supercritical fluid include, but are not limited to, nitrogen, carbon dioxide, and the combination thereof.

The foamed body 1 extends in a first longitudinal direction (X), and may have a sole area 101, an arch area 102 and a heel area 103 along the first longitudinal direction (X). The foamed body 1 is formed with a plurality of foamed pores 12, each of which extends in a second longitudinal direction (L). An angle (θ) defined between the first longitudinal direction (X) and the second longitudinal direction (L) may range from 0° to 60°.

Each of the foamed pores 12 extends in the second longitudinal direction (L) to terminate at two opposite lengthwise ends (p1, p2), and extends in a width direction perpendicular to the second longitudinal direction (L) to terminate at two opposite widthwise ends (w1, w2). Each of the foamed pores 12 has a maximum length (H) defined by a distance between the lengthwise ends (p1, p2), and a maximum width (W) defined by a distance between the widthwise ends (w1, w2). For each of the foamed pores 12, a ratio between the maximum length (H) and the maximum width (W) is at least 2:1. That is, each of the foamed pores 12 may be in an oval shape. In certain embodiments, the maximum length (H) of each of the foamed pores 12 is less than 6 mm.

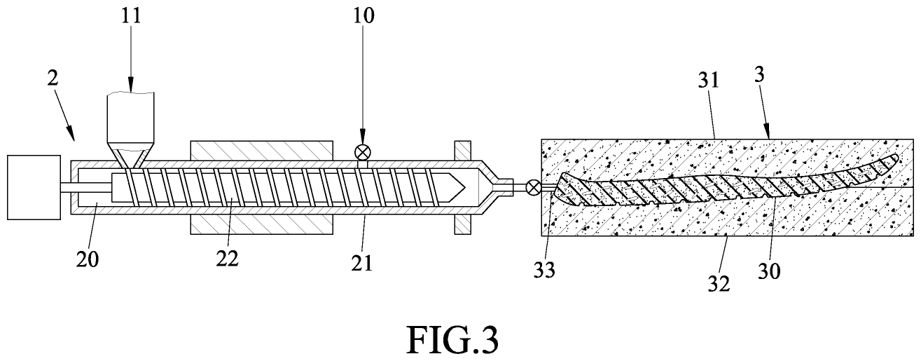

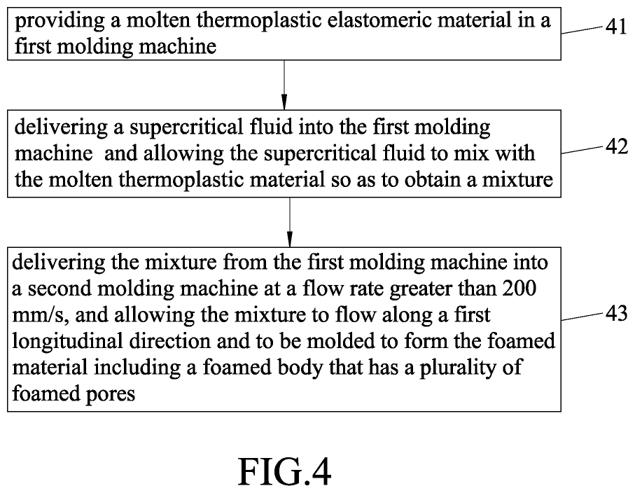

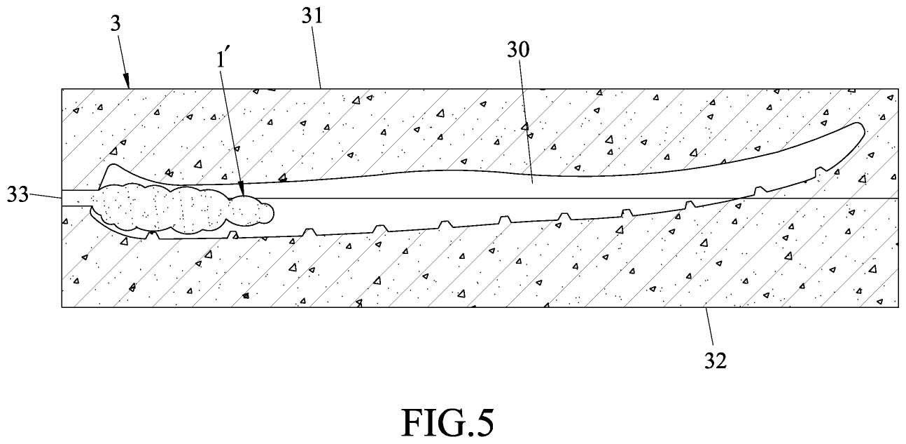

Referring to FIGS. 3 to 5, a first molding machine 2 and a second molding machine 3 are applied in an embodiment of a method for manufacturing the foamed material for shoes, which includes the following steps 41 to 43.

In step 41, the molten thermoplastic elastomeric material 11 is provided in the first molding machine 2.

According to this disclosure, the first molding machine 2 may be an injection molding machine or an extrusion molding machine, but is not limited thereto. In this embodiment, the first molding machine 2 includes a barrel 21 defining a chamber 20 for receiving the molten thermoplastic elastomeric material 11, and a screw rod 22 being rotatably mounted within the barrel 21.

In step 42, the supercritical fluid is delivered into the first molding machine 2 and is allowed to mix with the molten thermoplastic material 11, so as to obtain a mixture 1′.

The mixing process of the molten thermoplastic material 11 and the supercritical fluid can be conducted using techniques well-known to and commonly used by those skilled in the art (such as those disclosed in Taiwanese Patent Publication No. 1658076), and therefore the same is omitted herein for the sake of brevity. Moreover, the operating conditions for the mixing process in the chamber 20 are within the expertise and routine skills of those skilled in the art, and may be modified according to practical requirements. In this embodiment, the mixing process is conducted under a pressure that is higher than 0.5 Mpa (73 psi) and a temperature ranging from 100° C. to 300° C. The mixture 1′ includes 0.1 wt % to 5 wt % of the supercritical fluid and 99.9 wt % to 95 wt % of the molten thermoplastic elastomeric material 11, based on a total weight of the mixture 1′.

In step 43, the mixture 1′ is delivered from the first molding machine 2 into the second molding machine 3 at a flow rate of greater than 200 mm/s by virtue of, e.g., injection molding or extrusion molding, and is allowed to flow along the first longitudinal direction (X) and to be molded to form the foamed material which includes the foamed body 1 that has the plurality of foamed pores 12. In certain embodiments, the flow rate of the mixture 1′ is greater than 250 mm/s.

According to this disclosure, the second molding machine 3 includes an upper mold half 31 and a lower mold half 32 that cooperatively define a mold cavity 30 therebetween. The second molding machine 3 further includes an injection hole 33 that is adapted to fluidly communicate the mold cavity 30 with the chamber 20 of the barrel 21. In certain embodiments, the second molding machine 3 is gas-permeable. In other words, one of the upper mold half 31, the lower mold half 32 and the combination thereof may be made of a porous material to permit gas to escape therefrom, thereby maintaining the flow rate of the mixture 1′ to be greater than 200 mm/s.

In this embodiment, the screw rod 22 is driven to deliver the mixture 1′ from the chamber 21 of the first molding machine 2 and to flow into the mold cavity 30 of the second molding machine 3 through the injection hole 33. The mold cavity 30 is controlled to be under an atmospheric pressure, i.e., lower than the operating pressure of the chamber 21, such that the mixture 1′ starts to foam and to be molded within the mold cavity 30, so as to obtain the foamed body 1 that is formed with the foamed pores 12.

In addition, as the mixture 1′ flows rapidly from the injection hole 33 into the mold cavity 30, the mixture 1′ is subjected to a relatively high shear force, which is capable of promoting nucleation of the foamed pores 12 and extension of the same, such that the foamed pores 12 are increasingly being formed, thereby decreasing the density of the foamed body 1 to be lower than 0.35 g/cm³. The flow rate of the mixture 1′ greater than 200 mm/s may also shorten the time for the mixture 1′ to entirely fill the mold cavity 30. That is, the time difference for the mixture 1′ to be delivered from a region adjacent to the injection hole 33 (corresponding to the heel area 103 of the foamed body 1 to be formed) toward a region farthest away from the injection hole 33 (corresponding to the sole area 101 of the foamed body 1 to be formed) may be decreased, causing each of the foamed pores 12 to have a desired ratio (i.e., at least 2:1) of the maximum length (H) to the maximum width (W), and the maximum length of the foamed pores 12 may be maintained to be less than 6 mm (without the formation of large foamed pores). As such, the thus formed foamed body 1 may have the foamed pores 12 more evenly distributed therein.

The properties of foamed body 1 of the foamed material were evaluated according to the standard test methods as listed in Table 1, and the results are also shown therein.

TABLE 1

| Property | Test Method | Unit | Result |
|---|---|---|---|
| Shore C hardness | ASTM D2240 | Shore C | 60.4 |
| (at room temperature) | | | |
| Density | ASTM D297 | g/cm³ | 0.324 |
| Tensile strength | ASTM D412 | kg/cm² | 27.4 |
| Elongation | ASTM D412 | % | 323.3 |
| Tear strength | ASTM D624 | kg/cm | 23.0 |
| Compression set | ASTM D395 | % | 22.9 |
| Resilience by vertical rebound | ASTM D2632 | % | 47 |
| (at room temperature) | | | |
| Shrinkage | ASTM D1917 | % | 0.46 |
| Split tear strength | ASTM D3574 | kg/cm | 3.62 |

It should be noted that, the foamed bodies 1 with different properties can be obtained by varying the following factors: the weight percentages of the molten thermoplastic elastomeric material 11 and the supercritical fluid, the operating conditions (such as temperature and pressure) in the first molding machine 2 (i.e., the mixing process) and the second molding machine 3 (i.e., molding and foaming process), and the flow rate of the mixture 1′ in the second molding machine 3. In certain embodiments, the foamed body 1 has a hardness ranging from 40 to 80 Shore C as measured according to ASTM D2240, a resilience ranging from 35% to 80% as measured according to ASTM D2632, and a compression set ranging from 10% to 40% as measured according to ASTM D395. As such, the foamed material for shoes is expected to have a relatively high elasticity and is lightweight.

In sum, by rapidly delivering the mixture 1′ into the second molding machine 3 (i.e., controlling the flow rate to be higher than 200 mm/s), the foamed material for shoes of the disclosure can be obtained in an efficient and environmentally friendly manner without the need of applying chemical blowing agent. In addition, the foamed material for shoes of the disclosure may have a density lower than 0.35 g/cm³ due to a great amount of foamed pores 12 formed therein.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A foamed material for shoes, comprising:
a foamed body made by foaming a mixture including a molten thermoplastic elastomeric material and a supercritical fluid, and extending in a first longitudinal direction said foamed body having a density lower than 0.35 g/cm³, and including a plurality of foamed pores,
wherein
each of said foamed pores extends in a second longitudinal direction to terminate at two opposite lengthwise ends, and extends in a width direction perpendicular to the second longitudinal direction to terminate at two opposite widthwise ends,
each of said foamed pores has a maximum length defined by a distance between said lengthwise ends, and a maximum width defined by a distance between said widthwise ends; and
for each of said foamed pores, a ratio between said maximum length and said maximum width is at least 2:1.

2. The foamed material according to claim 1, wherein said molten thermoplastic elastomeric material is selected from the group consisting of a polyolefin elastomer, a thermoplastic elastomer, and combinations thereof.

3. The foamed material according to claim 2, wherein said thermoplastic elastomer is selected from the group consisting of a thermoplastic polyurethane, a thermoplastic styrene, a thermoplastic olefin, a thermoplastic vulcanizate, a thermoplastic polyester elastomer, and combinations thereof.

4. The foamed material according to claim 1, wherein said foamed body has a hardness ranging from 40 to 80 as measured according to ASTM D2240.

5. The foamed material according to claim 1, wherein said foamed body has a resilience ranging from 35% to 80% as measured according to ASTM D2632.

6. The foamed material according to claim 1, wherein said foamed body has a compression set ranging from 10% to 40% as measured according to ASTM D395.

7. The foamed material according to claim 1, wherein said maximum length of each of said foamed pores is less than 6 mm.

8. The foamed material according to claim 1, wherein said foamed body has a sole area, an arch area, and a heel area along said first longitudinal direction, an angle defined between said first longitudinal direction and said second longitudinal direction ranging from 0° to 60°.

9. A method for manufacturing a foamed material for shoes, comprising the steps of:
a) providing a molten thermoplastic elastomeric material in a first molding machine;
b) delivering a supercritical fluid into the first molding machine and allowing the supercritical fluid to mix with the molten thermoplastic material, so as to obtain a mixture; and
c) delivering the mixture from the first molding machine into a second molding machine at a flow rate of greater than 200 mm/s, and allowing the mixture to flow along a first longitudinal direction and to be molded to form the foamed material including a foamed body that has a plurality of foamed pores, wherein each of the foamed pores extends in a second longitudinal direction to terminate at two opposite lengthwise ends, and extends in a width direction perpendicular to the second longitudinal direction to terminate at two opposite widthwise ends,
each of the foamed pores has a maximum length defined by a distance between the lengthwise ends and a maximum width defined by the widthwise ends; and
for each of the foamed pores, a ratio between the maximum length and the maximum width is at least 2:1.

10. The method according to claim 9, wherein in step c), the mixture is delivered from the first molding machine into the second molding machine by injection molding.

11. The method according to claim 9, wherein in step c), the mixture is delivered from the first molding machine into the second molding machine by extrusion molding.

12. The method according to claim 9, wherein the molten thermoplastic elastomeric material is selected from the group consisting of a polyolefin elastomer, a thermoplastic elastomer, and combinations thereof.

13. The method according to claim 12, wherein the thermoplastic elastomer is selected from the group consisting of a thermoplastic polyurethane, a thermoplastic styrene, a thermoplastic olefin, a thermoplastic vulcanizate, a thermoplastic polyester elastomer, and combinations thereof.

14. The method according to claim 9, wherein in step c), the flow rate of the mixture is greater than 250 mm/s.

15. The method according to claim 9, wherein in step c), the second molding machine is made of a porous material.
